(19) United States
(12) Patent Application Publication
(10) Pub. No.: US 2008/0110508 A1
(43) Pub. Date: May 15, 2008

(54) Guiding of short aspect ratio poppets in a hot gas application

(75) Inventors: Joseph M. Searle, Scottsdale, AZ (US); Donald J. Christensen, Phoenix, AZ (US); Mark H. Baker, Scottsdale, AZ (US); George T. Woessner, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/598,930

(22) Filed: Nov. 13, 2006

(51) Int. Cl. F16K 15/00

(52) U.S. Cl. 137/533.17

(57) ABSTRACT

A valve comprises a valve body, a poppet, and a pin. The valve body includes an inlet, an outlet, and a fluid flow passage therebetween. The poppet is disposed in the valve body, and is moveable between a closed position, in which the poppet at least substantially restricts fluid from flowing through the fluid flow passage, and an open position, in which fluid is allowed to flow through the fluid flow passage. The pin is disposed in the valve body, and extends at least partially into the poppet. The pin is configured to guide poppet movement in the valve body between the closed position and the open position. In this configuration, the ratio of the poppet length to diameter can be less than one.

### TECHNICAL FIELD

The present invention generally relates to a valve, and more particularly relates to a valve with improved guidance.

### BACKGROUND

Valves are used to control gases or other fluids in various types of apparatus and vehicles, such as aircraft, rockets, and missiles. In certain situations, such as when valves are located in a vehicle's propulsion or attitude control systems, valves can be subject to hot gas effluent that reaches extremely high temperature and/or pressure.

Valves that are exposed to such hot gas environments generally include poppets designed to guide on their outer diameters. Such poppets are typically designed so that the ratio of the poppet length to diameter (L/D) is greater than or equal to one, in order to minimize potential jamming and cocking during operation. While such valves generally perform very well, there may be certain situations in which a poppet with a smaller length to diameter (L/D) ratio may be desired, for example where there are space constraints or where a poppet with a smaller length is desired for some other reason. In addition, improved stability and/or guidance may also be desired for valves in hot gas applications, regardless of the desired poppet length.

Accordingly, there is a need for a valve with improved stability and/or guidance, and/or that allows for a poppet with a smaller length to diameter (L/D) ratio. The present invention addresses one or more of these needs.

### BRIEF SUMMARY

An apparatus is provided for a valve. In one embodiment, and by way of example only, the valve comprises a valve body, a poppet, and a pin. The valve body includes an inlet, an outlet, and a fluid flow passage therebetween. The poppet is disposed in the valve body. The poppet is moveable between at least a closed position, in which the poppet at least substantially restricts fluid from flowing through the fluid flow passage, and an open position, in which fluid is allowed to flow through the fluid flow passage. The pin is disposed in the valve body, and extends at least partially into the poppet. The pin is configured to guide poppet movement in the valve body between the closed position and the open position.

In another embodiment, and by way of example only, the valve comprises a valve body, a poppet, a pin, and a bore region. The poppet is disposed in the valve body. The poppet is moveable between at least a closed position, in which the poppet at least substantially restricts fluid from flowing through the fluid flow passage, and an open position, in which fluid is allowed to flow through the fluid flow passage. The pin is disposed in the valve body, and extends at least partially into the poppet. The pin is configured to guide poppet movement in the valve body between the closed position and the open position. The bore region is formed in the poppet, and is configured to allow movement of the pin therein as the poppet moves between the closed position and the open position.

In yet another embodiment, and by way of example only, the valve comprises a valve body, a poppet, and a pin. The valve body includes an inlet, an outlet, and a fluid flow passage therebetween. The poppet is disposed in the valve body. The poppet has a length and a width, the length being less than the width. The poppet is moveable between at least a closed position, in which the poppet at least substantially restricts fluid from flowing through the fluid flow passage, and an open position, in which fluid is allowed to flow through the fluid flow passage. The pin is disposed in the valve body, and extends at least partially into the poppet. The pin is configured to guide poppet movement in the valve body between the closed position and the open position.

### BRIEF DESCRIPTION OF THE DRAWINGS

The present invention will hereinafter be described in conjunction with the following drawing figures, wherein like numerals denote like elements, and

FIG. 1 provides a side view of an embodiment of a valve for use in hot gas applications, shown in a closed position;

FIG. 2 provides a side view of the valve of FIG. 1, shown in an open position;

FIG. 3 provides a side view of another embodiment of a valve for use in hot gas applications, shown in a closed position;

FIG. 4 provides a side view of the valve of FIG. 3, shown in an open position;

FIG. 5 provides a close-up view of a portion of an embodiment of the valve of FIG. 1, showing a poppet with a recess and a sleeve, and a pin, that can be used in connection therewith;

FIG. 6 provides a close-up view of a portion of an embodiment of the valve of FIG. 1, showing a poppet with a recess, a sleeve, and a bushing, and a pin, that can be used in connection therewith;

FIG. 7 provides a close-up view of an embodiment of a poppet, with a pin formed as part of the poppet, that can be used in connection with the valve of FIG. 3; and

FIG. 8 provides a close-up view of another embodiment of a poppet, with a pin attached thereto, that can be used in connection with the valve of FIG. 3.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

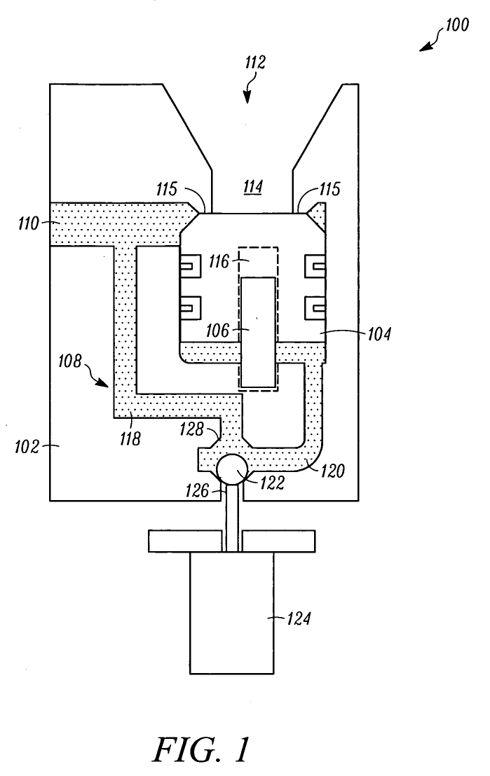

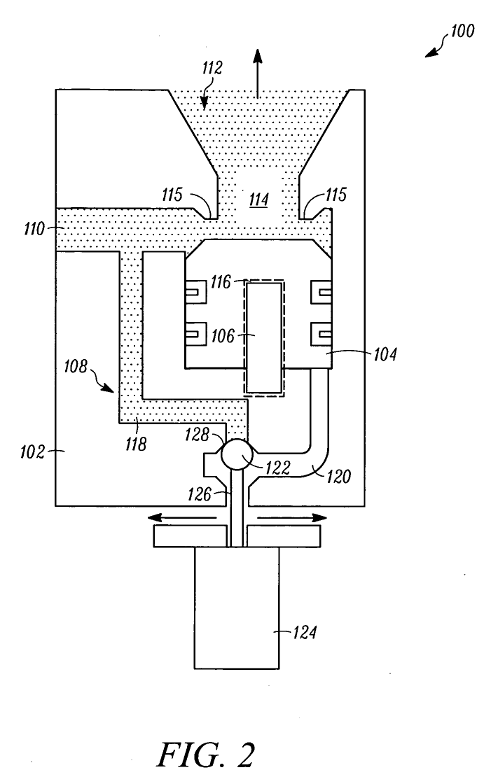

FIGS. 1 and 2 depict side views of first embodiments of a valve 100 for use in hot gas applications. The valve 100 includes a valve body 102, a poppet 104, a pin 106, and a position control system 108. The valve body 102 includes an inlet 110, an outlet 112, and a fluid flow passage 114 therebetween. In a preferred embodiment, the fluid flowing through the fluid flow passage 114, and other gas or fluid referenced herein, includes one or more hot gases. However, it will be appreciated that in certain embodiments other types of fluid may apply.

The poppet 104 is disposed in the valve body 102, and is movable between at least a closed position and an open position. When the poppet 104 is in the closed position, which is the position depicted in FIG. 1, the poppet 104 at least substantially restricts fluid from flowing through the fluid flow passage 114, for example by seating against a valve seat 115 formed in the valve body 102. Conversely, when the poppet 104 is in the open position, which is the position depicted in FIG. 2, fluid is allowed to flow through the fluid flow passage 114. In the embodiments depicted in FIGS. 1 and 2, the poppet 104 includes a bore region 116 which at least partially surrounds the pin 106, as will be described in greater detail further below. In a preferred embodiment the poppet 104 is made at least in part from a silicon carbide material; however, it will be appreciated that in other embodiments the poppet 104 can be made from any one or more of a number of different types of material.

The pin 106 is disposed in the valve body 102, and extends at least partially into the poppet 104. The pin 106 is configured to guide movement of the poppet 104 within the valve body 102 between the closed position and the open position. The pin 106 preferably provides a tight clearance within the bore region 116, while allowing for venting to avoid unwanted fluid entrapment. In one preferred embodiment, the pin 106 takes an approximately cylindrical shape with a flat surface on at least one end to allow for such fluid venting as the poppet 104 moves between the closed and open positions. However, it will be appreciated that the pin 106 can take any one of a number of different shapes, sizes, and configurations. In one preferred embodiment, the pin 106 is made of rhenium; however, it will be appreciated that the pin 106 may be made of any one of a number of different types of material, or combinations thereof. Similarly, as discussed below, the pin 106 can be placed in one of multiple different places within the valve 100.

Specifically, in the embodiments depicted in FIGS. 1 and 2, the pin 106 is incorporated with the valve body 102, and extends therefrom into a bore region 116 formed in the poppet 104. In such embodiments, the pin 106 can be formed as an integral part of the valve body 102, or separately formed and then coupled to the valve body 102. As will be described in greater detail further below, in other embodiments the pin 106 may instead be integrally formed as part of the poppet 104, or separately formed and then coupled to the poppet 104. It will be appreciated that in these latter embodiments, the bore region 116 is preferably formed in the valve body 102.

The depicted position control system 108 includes a first control conduit 118, a second control conduit 120, a control valve 122, and a valve actuator 124. The first control conduit 118 is coupled to the inlet 110, and is configured to receive fluid flow therefrom. The second control conduit 120 is coupled to the poppet 104, and is further selectively coupled to atmospheric pressure or to the first control conduit 118, depending on the position of the control valve 122, as determined by the valve actuator 124. The control valve 122 is configured to move between a first position, in which it seats against a first control seat 126, and a second position, in which it seats against a second control seat 128, as described below.

The valve actuator 124 may be implemented using any one of numerous different types of devices or configurations, but in a preferred embodiment includes a solenoid. When the valve actuator 124 moves the control valve 122 to the first position, against the first control seat 126, as shown in FIG. 1, the control valve 122 allows fluid flow from the first control conduit 118 to the second control conduit 120. Accordingly, when the control valve 122 is in the first position, fluid supplied to the second control conduit 120 is directed against the poppet 104, overcoming pressure against the poppet 104 via the inlet 110, and thereby moving the poppet 104 to the closed position depicted in FIG. 1. Conversely, when the valve actuator 124 moves the control valve 122 to the second position, against the second seat 128, as shown in FIG. 2, the control valve 122 blocks fluid from flowing from the first control conduit 118 to the second control conduit 120, and the second control conduit 120 is vented to atmospheric pressure. Accordingly, when the control valve 122 is in the second position, the fluid flow from the inlet 110 moves the poppet 104 to the open position depicted in FIG. 2.

The depicted position control system 108 is merely exemplary in nature. It will be appreciated that the valve 100 can include any one of a number of different types of control systems 108 and/or other devices for moving the poppet 104 between the closed position and the open position.

In addition, before proceeding further, it is noted that each of the FIGS. 1-8 show certain preferred implementations of embodiments of the valve 100 and/or portions thereof, for example using certain valve concepts from U.S. Pat. No. 6,895,991 (Woessner) and U.S. Pat. No. 6,951,317 (Woessner et al.). However, it will be appreciated that various embodiments of the valve 100 and/or portions thereof can also be utilized in any number of different implementations.

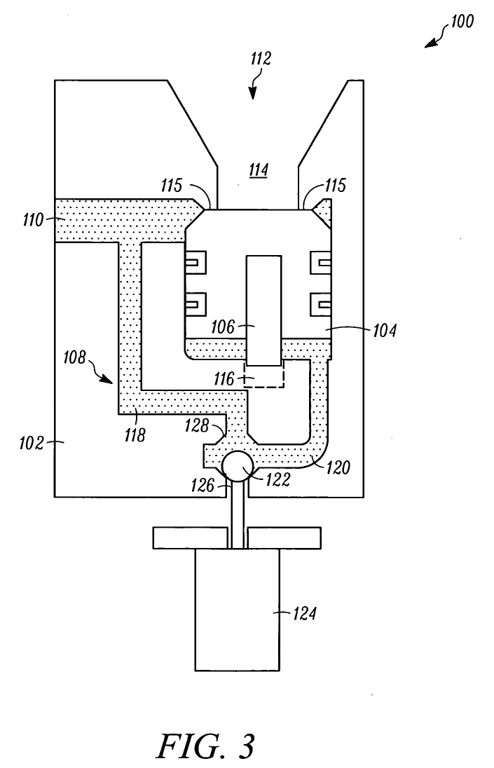

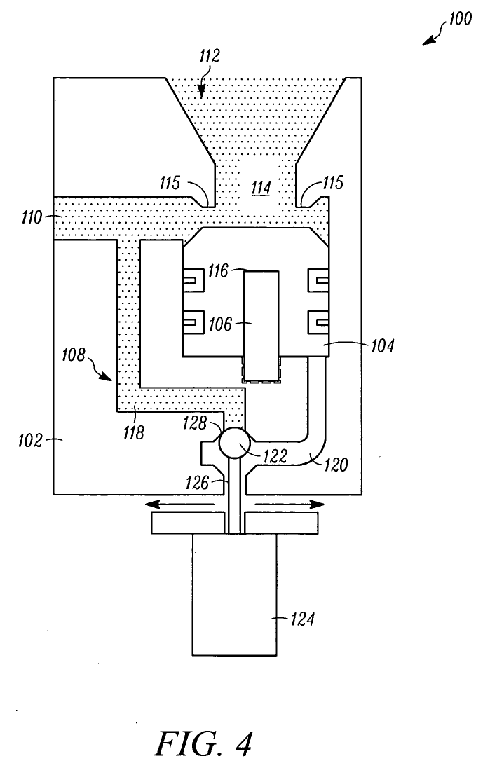

Turning now to FIGS. 3 and 4, alternate embodiments of the valve 100 system are depicted. Similar to the embodiments of FIGS. 1 and 2, the poppet 104 is disposed in the valve body 102, and is movable between at least a closed position, depicted in FIG. 3, and an open position, depicted in FIG. 4. Also similar to the embodiments of FIGS. 1 and 2, the pin 106 is at least partially surrounded by the bore region 116, and is configured to guide movement of the poppet 104 within the valve body 102 between the closed position and the open position. However, in the embodiments of FIGS. 3 and 4, the bore region 116 is formed in the valve body 102 instead of in the poppet 104, and the pin 106 is incorporated with, and extends from, the poppet 104. For example, the pin 106 can be either made as part of the poppet 104 or attached to, or otherwise coupled to, the poppet 104 in these embodiments. The pin 106 is configured to move within the bore region 116. Accordingly, as the poppet 104 moves between the closed and open positions, the pin 106 moves along with the poppet 104, through the bore region 116, between the two positions depicted in FIGS. 3 and 4.

The position control system 108 of FIGS. 3 and 4 is preferably identical to that depicted in FIGS. 1 and 2 and described above in connection therewith. Thus, a description thereof will not be repeated. However, as mentioned above, any one of a number of different types of control systems 108 and/or other devices can be utilized in connection with the valve 100.

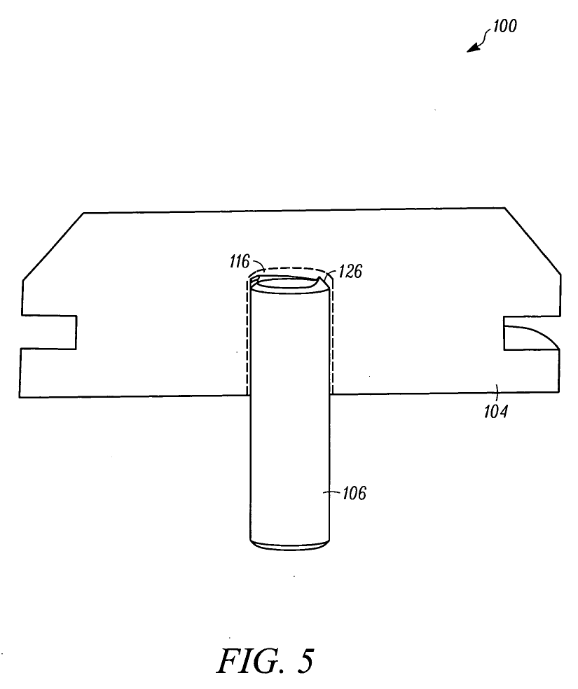

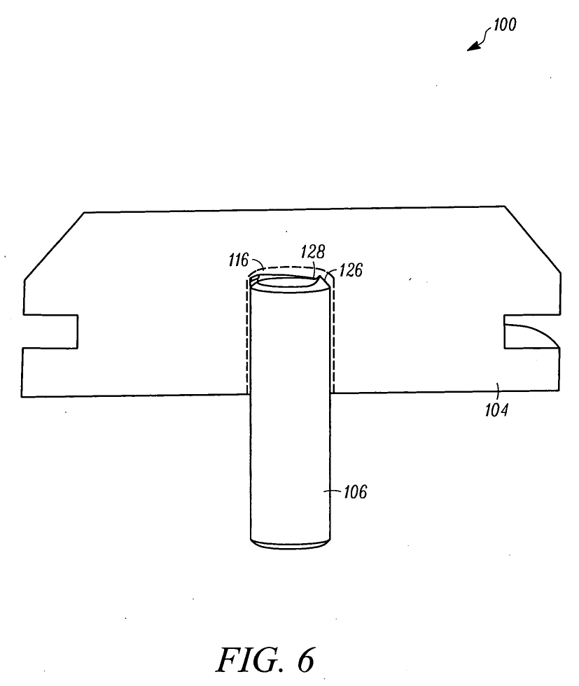

Turning now to FIGS. 5-8, close-up views are provided for the poppet 104 and the pin 106 according to various embodiments of the valve 100. Specifically, FIGS. 5 and 6 provide close-up views of a poppet 104 and pin 106 according to two different embodiments of the valve 100 of FIGS. 1 and 2, and FIGS. 7 and 8 provide close-up views of a poppet 104 and pin 106 according to two different embodiments of the valve 100 of FIGS. 3 and 4.

FIG. 5 provides a close-up view of a portion of a valve 100 with a poppet 104 disposed within the valve body 102, in one embodiment corresponding with the valve 100 of FIGS. 1 and 2. The bore region 116 is formed in the poppet 104, and is coated with a sleeve 130. The bore region 116 and the sleeve 130 at least partially surround the pin 106, which is coupled to, or part of, a non-depicted portion of the valve body 102. The pin 106 guides the poppet 104 as it moves between the closed and open positions, with the bore region 116 and the sleeve 130 surrounding a relatively smaller region of the pin 106 when in the closed position (depicted in FIG. 5) and a relatively larger region of the pin 106 when in the open position (not depicted in FIG. 5). The sleeve 130 also preferably functions as a seal to prevent unwanted leakage of fluid surrounding the poppet 104. The sleeve also provides strength to the poppet 104, in addition to providing sealing for the poppet 104. In one preferred embodiment the sleeve 130 is made at least in part from rhenium; however, it will be appreciated that the sleeve 130 can be made from any one of a number of different types of material known in the art, or combinations thereof. While a sleeve 130 may be useful in facilitating guidance of the poppet 104 and/or reducing friction or wear in certain embodiments, the sleeve 130 may not be needed in other embodiments.

FIG. 6 provides a close-up view of a portion of a valve 100 with a poppet 104 disposed within the valve body 102 in another embodiment corresponding with the valve 100 of FIGS. 1 and 2. The embodiment of FIG. 6 is similar to that depicted in FIG. 5, but also includes a bushing 132. In one preferred embodiment the bushing 132 is disposed between the sleeve 130 and the pin 106, so that the pin 106 directly contacts the bushing 132 during movement of the poppet 104. The bushing 132 can provide an improved contact surface between the pin 106 and the poppet 104.

The bushing 132 is preferably made of a material that facilitates smooth contact with the pin 106. For example, in the above-described example of a rhenium pin 106, the bushing 132 can be made of graphite, and/or another material that would provide a smooth contact surface. In one preferred embodiment the bushing 132 includes a cylindrically shaped graphite ring that fits at least substantially snug against the sleeve 130 in the bore region 116. The bushing 132 may also include one or more small, non-depicted openings to allow venting of gas therethrough. However, it will be appreciated that the bushing can be made of any one of a number of different types of material known in the art, or combinations thereof, and can take any one of a number of different shapes, sizes, and configurations. Similarly, while FIG. 6 depicts both a sleeve 130 and a bushing 132, it will be appreciated that in certain embodiments the valve 100 may include a bushing 132 without a sleeve 130, or vice versa, and that in certain other embodiments neither a bushing 132 nor a sleeve 130 may be needed.

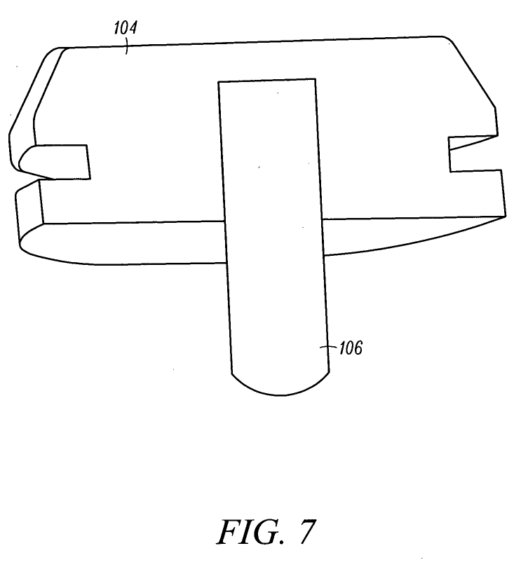

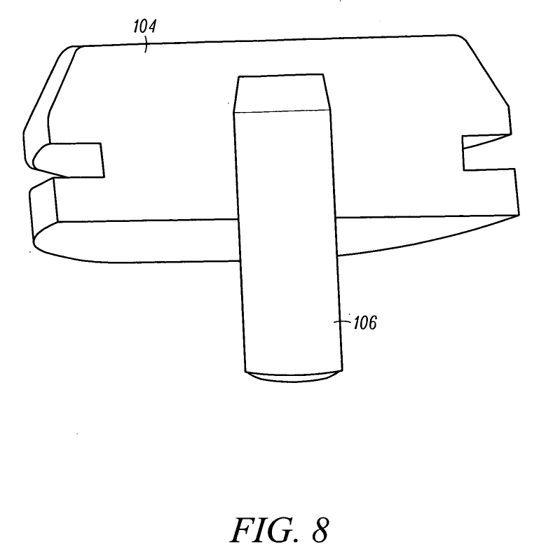

FIGS. 7 and 8 provide close-up views of a poppet 104 and a pin 106 corresponding with the valve 100 of FIGS. 3 and 4, in which the pin 106 is incorporated with the poppet 104 and extends therefrom. Specifically, in FIG. 7 the pin 106 is formed as an integral part of the poppet 104, while in FIG. 8 the pin 106 is attached to, or otherwise coupled to, the poppet 104. In either case, the pin 106 is configured to move with the poppet 104, and through a bore region 116 formed in the valve body 102 (not depicted in FIGS. 7 and 8), as the poppet 104 moves between the closed and open positions. The bore region 116 in the valve body 102 may also include one or more sleeves 130, bushings 132, and/or other features similar to those described above in connection with FIGS. 5 and 6.

In one preferred embodiment depicted in FIG. 8, the pin 106 can be coupled to the poppet 104 via an interference fit. However, it will be appreciated that the pin 106 can also be coupled to the poppet 104 via any one of a number of other types of coupling, such as bonding, welding, threading, epoxy techniques, mechanical coupling, electrical coupling, various other types of attachment, and/or any one of a number of other different types of coupling.

The selection of a particular embodiment for the valve 100 may depend in part on the particular application, and the corresponding needs and desires. For example, if a particular application calls for a relatively lightweight poppet 104 and/or a poppet 104 that is easier to manufacture, then the pin 106 can be incorporated with the valve body 102, as shown in the embodiments depicted in FIGS. 1, 2, 5, and 6. Conversely, if an even more robust guidance system is desired, and/or if poppet 104 weight or ease of manufacturing is less important, in a particular application, then the pin 106 can be incorporated with the poppet 104, as shown in the embodiments depicted in FIGS. 3, 4, 7, and 8.

Regardless of whether the pin 106 is incorporated with the valve body 102 or the poppet 104, any of these embodiments can provide improved stability and guidance even when the ratio of poppet 104 length to diameter (L/D) is less than one, for example as shown in the embodiments of the poppet 104 depicted in FIGS. 5-8. This can allow for the optimal poppet 104 to be selected for a particular valve 100 application, without being limited by specific constraints as to poppet 104 length and width. In such embodiments, the effective L/D ratio (namely the ratio of the pin 106 length to the pin 106 diameter) can be significantly greater than one, even when the L/D ratio of the poppet 104 is significantly less than one, as is the case in each of the embodiments depicted in FIGS. 5-8. It will be appreciated that the poppet 104 can take any one of a number of different shapes, sizes, and configurations, with any one of a number of different L/D ratios. As mentioned above, the pin 106, and the various other features of the valve 100, can each similarly take any one of numerous different shapes and sizes.

Also as mentioned above, the various components of the valve 100 can each be made from any one or more of a number of different types of material. Preferably components that contact one another are made of complementary materials that provide a good contact surface, such as the above-mentioned use of a rhenium pin 106 with a graphite bushing 132 and/or a rhenium sleeve 130. Moreover, the valve 100, and the components thereof, are preferably made of one or more heat resistant materials that are configured to withstand the particular temperature, pressure, and other conditions encountered in hot gas applications.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A valve comprising:
a valve body including an inlet, an outlet, and a fluid flow passage therebetween;
a poppet disposed in the valve body and moveable between at least:
a closed position, in which the poppet at least substantially restricts fluid from flowing through the fluid flow passage; and
an open position, in which fluid is allowed to flow through the fluid flow passage; and
a pin disposed in the valve body and extending at least partially into the poppet, the pin configured to guide poppet movement in the valve body between the closed position and the open position.

2. The valve of claim 1, wherein:
the poppet has a length and a width; and
the poppet length is less than the poppet width.

3. The valve of claim 1, wherein:
the poppet is made at least in part from a silicon carbide material; and
the pin is made at least in part from rhenium.

4. The valve of claim 1, further comprising:
a bore region formed in the valve body, the bore region configured to allow movement of the pin therein as the poppet moves between the closed position and the open position.

5. The valve of claim 4, wherein the pin is coupled to the poppet.

6. The valve of claim 5, wherein the pin is coupled to the poppet via an interference fit.

7. The valve of claim 4, wherein the pin is formed as an integral part of the poppet.

8. A valve comprising:
a valve body including an inlet, an outlet, and a fluid flow passage therebetween;
a poppet disposed in the valve body and moveable between at least:
a closed position, in which the poppet at least substantially restricts fluid from flowing through the fluid flow passage; and
an open position, in which fluid is allowed to flow through the fluid flow passage;
a pin disposed in the valve body and extending at least partially into the poppet, the pin configured to guide poppet movement in the valve body between the closed position and the open position; and
a bore region formed in the poppet, the bore region configured to allow movement of the pin therein as the poppet moves between the closed position and the open position.

9. The valve of claim 8, wherein:
the poppet has a length and a width; and
the poppet length is less than the poppet width.

10. The valve of claim 8, wherein the poppet is made at least in part from a silicon carbide material.

11. The valve of claim 8, wherein the pin is made at least in part from rhenium.

12. The valve of claim 8, further comprising:
a sleeve disposed within the bore region and surrounding at least a portion of the pin.

13. The valve of claim 12, wherein the sleeve is made at least in part from rhenium.

14. The valve of claim 8, further comprising:
a bushing disposed within the bore region and surrounding at least a portion of the pin.

15. The valve of claim 14, wherein the bushing is made at least in part from graphite.

16. A valve comprising:
a valve body including an inlet, an outlet, and a fluid flow passage therebetween;
a poppet disposed in the valve body, the poppet having a length and a width, the length being less than the width, the poppet moveable between at least:
a closed position, in which the poppet at least substantially restricts fluid from flowing through the fluid flow passage; and
an open position, in which fluid is allowed to flow through the fluid flow passage; and
a pin disposed in the valve body and extending at least partially into the poppet, the pin configured to guide poppet movement in the valve body between the closed position and the open position.

17. The valve of claim 16, further comprising:
a bore region formed in the poppet, the bore region configured to allow movement of the pin therein as the poppet moves between the closed position and the open position.

18. The valve of claim 17, further comprising:
a sleeve disposed within the bore region and surrounding at least a portion of the pin.

19. The valve of claim 17, further comprising:
a bushing disposed within the bore region and surrounding at least a portion of the pin.

20. The valve of claim 19, wherein:
the pin is made at least in part from rhenium; and
the bushing is made at least in part from graphite.
